(19) United States
(12) Patent Application Publication
(10) Pub. No.: US 2018/0177578 A1
(43) Pub. Date: Jun. 28, 2018

(54) LIGHT GENERATOR FOR WHITENING TEETH

(71) Applicant: Stephane BOCHENEK, Yerres (FR)

(72) Inventor: Stephane BOCHENEK, Yerres (FR)

(21) Appl. No.: 15/820,247

(22) Filed: Nov. 21, 2017

(30) Foreign Application Priority Data
Dec. 28, 2016 (EP) 16207177.3

(51) Int. Cl. A61C 19/06; H05B 33/08

(52) U.S. Cl. CPC A61C 19/066; G06F 3/0482; H05B 33/0845

(57) ABSTRACT

The light generator comprises a plurality of light-emitting diodes for emitting light (101) and control means (12, 14, 15). According to the invention, the light-emitting diodes (LED) for emitting light are square or rectangular miniature components, capable of emitting a high-intensity light with low current consumption, and are of the SMC or “surface-mount component” type. According to another embodiment, the light-emitting diodes for emitting light are sub-miniature components. According to a special feature, the generator comprises a programmable microcontroller (3) allowing a plurality of operating modes.

The invention generally relates to teeth whitening. Specifically, the invention relates to a light generator with light-emitting diodes for whitening teeth.

The most frequent causes of tooth discolouration among humans are ageing and the consumption of dyeing substances. With age, the mineral structure of the teeth changes and this may reduce the brightness of the enamel. Teeth can also become coloured by bacterial pigments, food products consumed, tobacco and certain drugs.

Teeth whitening has gained popularity in recent years, and various solutions are offered, either directly to consumers commercially, or by dentists to their patients.

A known solution which is sold directly to consumers comprises a whitening agent, in the form of a gel or toothpaste, and a light generator. The dental gel is applied to the surface of the teeth and the light generator is used to activate and polymerise the whitening agent. Various compositions of whitening agents are known, the most effective of which contain hydrogen peroxide. The associated light generators are lightweight, portable devices which users can hold in their hands and place in their mouths in order to cast light on the whitening agent. These light generators use LEDs (Light Emitting Diodes) which emit a cold blue, ultraviolet-rich light.

The known light generators have a certain number of drawbacks and shortcomings.

The blue light emitted generally is not uniform, and the whitening agent on the surface of the teeth is not homogeneously lit. This can cause whiteness defects which remain on the teeth after the treatment.

The light exposure time and the light intensity are rarely adjustable and are not sufficiently controlled in the known generators, which are most commonly designed and sold for specific whitening compositions. Even when adjustment is possible or the exposure can be controlled, this possibility is still very limited and inaccurate. Users might then run the risk of overexposure to the light, in particular when the teeth whitening gel used is not suited to the generator or vice-versa. Overexposure to light can cause overheating of the dental pulp and the gum tissue, with potential consequences for dental and oral health.

The present invention aims to provide solutions to the drawbacks in the prior art stated above, by proposing a new-generation light generator that is well suited for direct use by consumers as well as by professionals.

According to a first aspect, the present invention relates to light generator for whitening teeth in combination with a whitening dental gel comprising a plurality of light-emitting diodes for emitting light and control means. According to the invention, the light-emitting diodes for emitting light are square or rectangular miniature components, capable of emitting a high-intensity light with low current consumption, and are of the SMC or “surface-mount component” type.

According to another embodiment, the light-emitting diodes for emitting light are sub-miniature components.

According to a special feature of the invention, the light-emitting diodes for emitting light are mounted electrically in parallel and supplied by a diode driver circuit such as a current generator.

According to another special feature of the invention, the control means comprise a programmable microcontroller allowing the generator to operate according to a plurality of operating modes.

According to yet another special feature of the invention, the generator also comprises a screen and a plurality of buttons connected to the programmable microcontroller for controlling the generator in said plurality of operating modes via menus which are displayed on the screen and actions of pressing said buttons.

According to yet another special feature of the invention, the light-emitting diodes for emitting light are monochromatic or polychromatic.

Other advantages and features of the present invention will become clear from reading the following descriptions of a plurality of specific embodiments in reference to the appended drawings, in which:

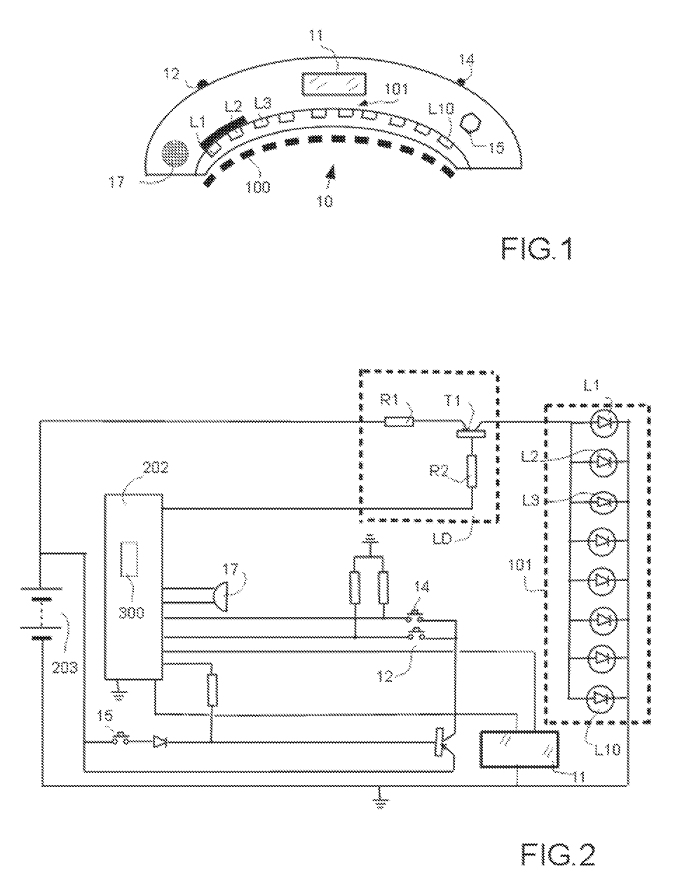

FIG. 1 is a top view of a light generator according to the invention;

FIG. 2 is the wiring diagram of the light generator of FIG. 1.

The hardware architecture and the operation of a specific embodiment 1 of the light generator according to the invention are described hereunder in reference to FIG. 1 and FIG. 2.

This generator 1 is presented in the form of a housing intended for being hand-held and having a substantially semi-circular front portion 10 to match the curve of a human jaw to which it must be applied.

The outer top view of the generator 1 in FIG. 1 shows the various human-machine interface means with which the generator is equipped. These interface means comprise, in particular, a screen 11, control buttons 12, 14, 15 and a buzzer 17 located inside the housing and leading to the outside.

The button 15 is an ON/OFF button. The buttons 12 and 14 are used to adjust the display of the hours and the minutes, so as to define the time at which the sound made by the buzzer 17 appears and to control the intensity of the light emitted by the generator 1.

Inside its housing, the generator 1 essentially includes a duct 100 and a diode array circuit 101 which follow the semi-circular shape of the front portion 10 of the generator. A printed circuit is also provided, which is intended for containing the various elements of a control circuit described explicitly above by means of FIG. 2.

The control circuit includes a programmable microcontroller 202, a rechargeable battery 203, the buzzer 17, and the buttons 12, 14, 15, of which the portions visible outside the housing are shown in FIG. 1.

In this embodiment of the invention, the duct 100 is intended for allowing the assembly of a mouthpiece (not shown) on the generator 1. Users place this mouthpiece between their lips and gums. It helps hold the generator 1 in position relative to the teeth to be treated and collects saliva substances. It is removable to allow it to be cleaned and replaced if need be.

The diode array circuit 101 is made up of a plurality of light-emitting diodes L1, L2, . . . , L10 which are mounted electrically in parallel and includes the cathodes thereof connected together to a mass of the circuit and supplied with current by an LD circuit, which is a diode driver circuit, referred to as LED driver, configured as a current generator. The current generator function of the LD circuit is obtained conventionally herein by means of a PNP transistor T1 and two resistors R1 and R2. A base electrode of the transistor T1 is connected to a control output of the microcontroller 202 which controls the current injected into the LED diodes. The microcontroller 202 can also control and adjust the light intensity which is emitted by the generator 1.

According to the invention, the LED diodes are square or rectangular SMC components (Surface-Mount Components). The LED diodes used in the invention are miniature or sub-miniature components, capable of emitting high-intensity light with low current consumption.

The LEDs used herein are, for example, of the same type as those sold by the company Philips in its Lumineds range (“Philips” and “Lumineds” are registered trademarks).

The LED diodes are generally chosen to have the light-emission wavelength which reacts best with the whitening dental gel used. A cold blue light or a wavelength in the range of 480 nm to 510 nm are often suitable. According to the invention, depending on the intended use of the generator, monochromatic, dichromatic or trichromatic LED diodes may be used, the polychromatic diodes allowing the colour of the emitted light to be adapted to different whitening dental gels used with the same generator.

The invention allows the production of dense, close-set rows of LED diodes, comprising a larger number of diodes per row, without increasing the electricity consumption of the generator, or even reducing same, compared with the generators of the prior art. This larger number of diodes, made possible by the square or rectangular shape of the diodes and the use of surface-mount technology, substantially improves the uniformity of the light beam emitted by the generator according to the invention, compared with the generators of the prior art.

In addition to the diode array circuit 101, the printed circuit also has all the other electronic and electrical components of the generator 1 and provides the electrical connections necessary for producing the electronic circuit of the generator 1.

In this embodiment, the microcontroller 202 is also a surface-mount component which is added to the printed circuit. The microcontroller 202 is managed by a microprogram contained in a memory 300 in order to control the operation of the entire generator 1. It should be noted herein that said microprogram may advantageously be loaded onto the microcontroller 202 via a micro-USB socket (not shown in the figures) when programming the apparatus at the end of the production thereof.

The rechargeable battery 203 is typically a Lithium-Ion battery and can be recharged via a micro-USB socket, for example, under the control of the microcontroller 202.

The buzzer 17 provides a human-machine interface by emitting sounds corresponding, for example, to acknowledging the pressing of a button, to the end of a light-exposure period, etc.

The screen 11 and the buttons 12, 14, 15 are essential elements which allow the generator to be controlled as follows:
The button 15 switches the generator of the invention on and off.
The button 12 causes the screen 11 to light up, if need be.
The button 12, when pressed for longer than 5 s, for example, can be used to set the time that appears on the screen 11.
The button 12, when the generator is in the time-setting state, allows the adjustment of the hours in increasing order.
The button 14, when the generator is in the time-setting state, allows the adjustment of the minutes in increasing order.
The button 14 allows, when the screen 11 is lit, the sound of the buzzer 17 to be programmed by 10-minute frames, for example.
The button 14, when pressed for longer than 5 s, for example, allows the light intensity to be adjusted according to three levels, for example.

Thus, a plurality of operating modes can be obtained.

As shown in FIG. 2, all the buttons 12, 14 and 15 are connected to an input port of the microcontroller 202. The screen 11 connected to an output port of the microcontroller 202 and receives its display data from same. The buzzer 17 is also connected to a dedicated input/output port of the microcontroller 202.

In all the embodiments of the generator of the invention, the microcontroller 202 only determines choices and treatment possibilities that are compatible with the whitening agent used and with the dental and oral health of the user.

The invention is obviously not limited to the embodiments which have been described specifically herein as examples. A person skilled in the art, according to the applications of the invention, may provide different modifications and variants that fall within the scope of the appended claims.

1. Light generator for whitening teeth in combination with a whitening dental gel comprising a plurality of light-emitting diodes (101) for emitting light and control means, characterised in that said light-emitting diodes (LED) for emitting light are square or rectangular miniature components, capable of emitting a high-intensity light with low current consumption, and are of the SMC or “surface-mount component” type.

2. Light generator according to claim 1, characterised in that said light-emitting diodes (LED) for emitting light are sub-miniature components.

3. Light generator according to claim 1, characterised in that said light-emitting diodes (LED) for emitting light are mounted electrically in parallel (101) and supplied by a diode driver circuit such as a current generator (LD).

4. Light generator according to claim 1, characterised in that said control means comprise a programmable microcontroller (202) allowing the generator (1) to operate according to a plurality of operating modes.

5. Light generator according to claim 4, characterised in that it comprises a program memory which contains a microprogram (300) for controlling the generator (1) installed in said programmable microcontroller (202).

6. Light generator according to claim 4, characterised in that it comprises a screen (11) and a plurality of buttons (12, 14) connected to said programmable microcontroller (202) for controlling the generator (1) in said plurality of operating modes via menus which are displayed on said screen (11) and actions of pressing said buttons (12 and 14).

7. Light generator according to claim 1, characterised in that said light-emitting diodes (LED) for emitting light are monochromatic or polychromatic.
